(19) United States
(12) Patent Application Publication
(10) Pub. No.: US 2013/0282714 A1
(43) Pub. Date: Oct. 24, 2013

(54) Personalized Redirection Identifiers

(71) Applicant: Shane Lathrom, San Bernardino, CA (US)

(72) Inventor: Shane Lathrom, San Bernardino, CA (US)

(73) Assignee: Yumber, Inc., San Bernardino, CA (US)

(21) Appl. No.: 13/450,141

(22) Filed: Apr. 18, 2012

(51) Int. Cl. G06F 17/30; G06F 15/16

(52) U.S. Cl. 707/736; 707/E17.014; 707/E17.005

(57) ABSTRACT

Personalized redirection identifiers are described. The personalized redirection identifiers allow Internet users to access information on the Internet by using simple text description without remember a web page address. A method comprises receiving an identification term, receiving a target, receiving a long description for the target, and creating a redirection identifier by combining the identification term and the target. A database record based on the target, the long description and the redirection identifier is stored for later searching and retrieval. The method may be performed on a server and accessed by a computing device.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to accessing information on the Internet or other heterogeneous widespread network.

2. Description of the Related Art

The location of information in Internet is linked with a Universal Resource Locator (“URL”). A URL is executable by a web browser, such as, Microsoft Internet Explorer, Mozilla Firefox, Opera, and Apple Safari. A URL is represented by a string of characters comprising alphabetic characters, numbers and symbols. It is a common practice among Internet users to share a URL by using methods, such as, copying and pasting, forwarding and posting the URL address. A URL may also be shared via email, instant messaging (“IM”), social networking sites, web pages and publication.

With the growth of the Internet, sharing of URLs for exchanging and retrieving Internet information has grown rapidly. URLs may be shared online as well as offline. Often, sharing of URLs requires memorization of URL characters, domain names, file names and extensions. This makes the sharing of URLs a lengthy, error prone process. The length or a URL may be aesthetically unpleasing. It is therefore difficult to correctly memorize and efficiently share URLs. Internet users often forget URLs and lose their ability to share information, both online and offline.

A technique called URL Shortening has made Short URLs that are shorter in length, improving upon lengthy and aesthetically unpleasing URLs. However, the need to memorize unique keys, characters and top-level domains (“TLD” or “TLDs”) did not change in Short URLs. Given the difficulty in sharing, copying and memorizing URLs and Short URLs, retrieving information from a specific location remains difficult for users of Internet-capable devices. There is therefore a great need for a method that provides Internet users the ability to easily access documents and files such as webpages from networked computing devices.

### DESCRIPTION OF THE DRAWINGS

FIG. 1 is a schematic diagram of an embodiment of a network configuration within which methods and systems for personalized redirection identifiers may be practiced.

FIG. 2 is a use case diagram of scenarios in which a user launches, creates and searches a redirection identifier.

FIG. 3 is a screen shot of a user interface for creating a redirection identifier.

FIG. 4 is a screen shot of a user interface for searching for a redirection identifier.

FIG. 5 is a screen shot of a user interface for launching a redirection identifier.

FIG. 6 is a flow diagram of a method for creating a redirection identifier.

FIG. 7 is a flow diagram of a method for searching for a redirection identifier.

FIG. 8 is a flow diagram of a method for launching a redirection identifier.

FIG. 9 is a flow diagram of a method for creating redirection identifiers from a batch list.

FIG. 10 is a flow diagram of a method for verifying the existence of a redirection identifier.

FIG. 11 is a diagram showing a structure of a redirection identifier.

FIG. 12 is a table illustrating an organization of redirection identifiers in a database.

FIG. 13 is a flow diagram of a method showing launch modes of a method and system for personalized redirection identifiers.

FIG. 14 is a schematic diagram of a computing device which may be used for implementing and/or accessing a method and system for personalized redirection identifiers.

### DETAILED DESCRIPTION

The systems and methods described herein improve the ability of users to easily navigate the Internet and share Internet web page locations. The systems and methods described herein eliminate the need for a user to memorize URLs for sharing and accessing Internet information. The systems and methods described herein eliminate the need for a user to remember the directory structure of URLs while sharing the URLs. The systems and methods described herein eliminate the need for a user to remember the details about the location of information. Further, the systems and methods described herein also eliminate the need for an Internet user to memorize a local file address in a local computer as well as a FTP (File Transfer Protocol) address of a file stored remotely, while sharing such files.

Described herein are methods and systems to provide personalized redirection identifiers in an Internet-capable device (also “user device”) for accessing Internet information by combining an account anchor, a universal resource locator (“URL”), and an identification term for the URL. The account anchor (also called “anchor term” or “anchor account”) comprises a term or text to identify a user by using a text string that may comprise a username, a domain name, an email address, a student identification number, or a phone number. An account anchor may also refer to a specific prefix applied to a redirection identifier (of a web site or other information). The prefix may be an individual username, domain name, email address, student ID number, phone number, identification number (employee, student, and so forth), etc. The method and system for personalized redirection identifiers described herein are not limited to sharing Internet information. The method and system for personalized redirection identifiers described herein may also be used to launch and/or search a local file on a local machine (“file:///”) or a file on a server available using an FTP address (“ftp://”), and to create a redirection identifier for a local file (local link) or FTP address. FTP stands for File Transfer Protocol.

Advantageously, the method and system for personalized redirection identifiers described herein improves the navigation and sharing of web page locations on the Internet. The method and system for personalized redirection identifiers described herein also eliminates the need to memorize URLs for sharing and accessing Internet information. The method and system for personalized redirection identifiers described herein invention eliminates the need for an Internet user to remember the directory structure of URLs while sharing the URLs, by creating a redirection identifier for each URL or other target (described below). After a redirection identifier is created, the redirection identifier and related information are stored in a database for future reference. Internet information may be accessed by an Internet user executing a redirection identifier, thus, eliminating the need for the Internet user to remember or key-in a URL address in an Internet-capable device. The redirection identifier is executable in a web browser or may be launched via an app. Further, the method and system for personalized redirection identifiers described herein maintains the privacy of a user while sharing Internet information. Privacy is maintained by eliminating the need to use email, short message service (SMS or text message), FACEBOOK, LINKEDIN or other application that may reveal or trace the identity of the user. The method and system for personalized redirection identifiers described herein also eliminates the need to remember information. The method and system for personalized redirection identifiers described herein also eliminates the need to memorize a local file address in a local computer and a FTP address of a file stored remotely, while sharing such files.

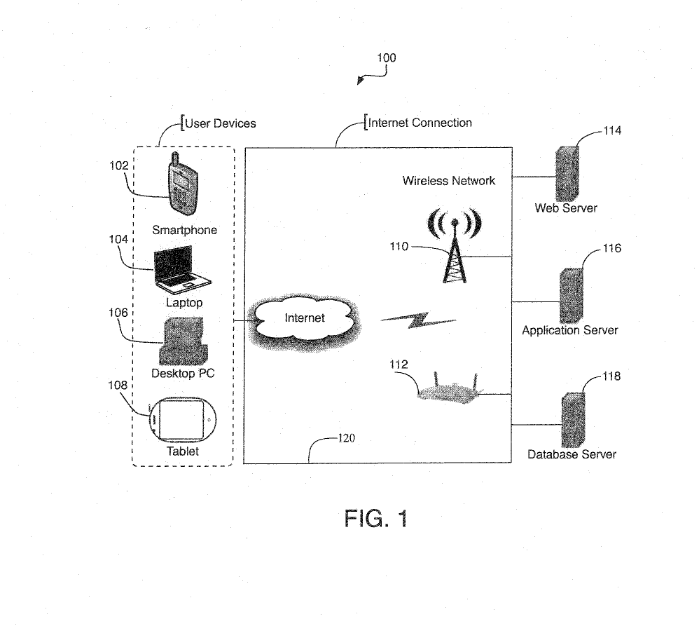

FIG. 1 shows a schematic diagram of a network configuration 100 for practicing embodiments of the method and system for personalized redirection identifiers described herein. A user device or devices may be connected to the Internet using a wireless network or wired network. A user device includes a computing device, electronic device or communications device capable of accessing the Internet, including, for example, a smartphone 102, laptop 104, desktop PC 106 or tablet 108. A user device also includes an automobile, boat, kitchen appliance or other device capable of running an Internet browser and accessing the Internet. The wireless network comprises a cellular tower 110, a router 112, switches, and/or other communications devices. User devices connect to servers comprising one or more of each of a web server 114, an application server 116, a database server 118, and other servers. The servers are connected to a user device through the wireless network (110 or 112) and/or the wired network 120. The wired network 120 or the wireless network (110 or 112) may employ technologies and protocols comprising Ethernet technology, and may be or include one or more of each of a Local Area Network (LAN), a Wide Area Network (WAN).

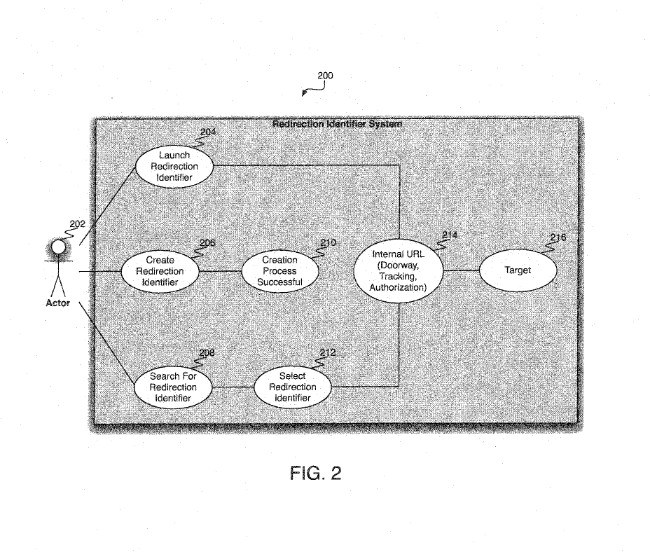

FIG. 2 is a use case diagram 200 of scenarios in which a user launches, creates and searches a redirection identifier. The actor 202 has three options to choose from: to launch a redirection identifier (action 204), to create a redirection identifier (action 206), and to search for a redirection identifier (action 208). When the actor 202 launches a redirection identifier (action 204), the system provides the actor 202 an internal URL doorway and tracking page used for tracking access to and launching an external URL (action 214). The internal URL doorway and tracking page may be a URL from a host server. The tracking page may track information relevant to a website and display commercial applications relevant to a business. Such relevant information and commercial applications may include advertisements, statistics, social media information, and so forth.

After action 214, the system launches a target (action 216). The target may be an external URL, an email address, a phone number, a tracking number (such as from a package or postage delivery company), an identification card, credit card number, social security number, a payment gateway, a software app or application, an API command, a FACEBOOK account name, a FACEBOOK page, a TWITTER account, a TWITTER page, an online account ID, a web page associated with an online account of a person or business, medical information stored online, banking accounts or information stored online, and others. The target may be any of these or multiple of these. When a target is launched an appropriate application may be executed to view or take action with the target. For example, when the target is an email address, and email application or client may be called with the email address as an argument. When a web page address is launched, a browser is executed with the web page as an argument. When the target is a phone number, a phone dialer is launched with the phone number as an argument.

In one embodiment, when there are multiple targets for a redirection identifier, the system may automatically select an appropriate target based on the kind of device being used to access the system, based on the geo-location, and others. For example, if the system determines that the user is accessing the system from a tablet computing device or personal computer, the system provides a URL to the user. If the system determines that the user is on a mobile phone, the system provides a phone number to the user. If the system determines that the user is at a geo-location of a restaurant, the system may provide a credit card number to a user. The system is intuitive such that if the user is accessing a web browser, the system will contextually determine the desired redirection request is for a URL; if launched via a phone dialer application, the system will contextually determine that a phone number is preferred; and if launched from within an email client, the system contextually determines an email address is preferred.

If there are multiple relative pieces of data available, for example, from within a tablet or smartphone, then the system may provide the user a list of the available targets to launch. This may be accomplished transparently to protect the owner of the redirection identifier's data from within the phone or tablet application through masking, encrypting, or requiring a password.

When there are multiple targets for a redirection identifier, the system may provide a list of all targets to a user. When a list of targets is provided, they may be ordered based on kind of target the system determines the user most likely prefers. This preference may be based on user selected options, prior user history and interaction with the system, most recently used applications, geo-location (for example, work, home, store, highway, etc.), access device kind (for example, tablet or mobile phone), and others.

The actor 202 may create a redirection identifier using the system (action 206). The system sends a successful creation notice to the actor at action 210 upon creation of a redirection identifier.

The actor 202 may search for a redirection identifier (action 208) and select the searched redirection identifier (action 212). After a selection is made, the system initializes the internal URL doorway and tracking page (action 214), and the system launches target (action 216).

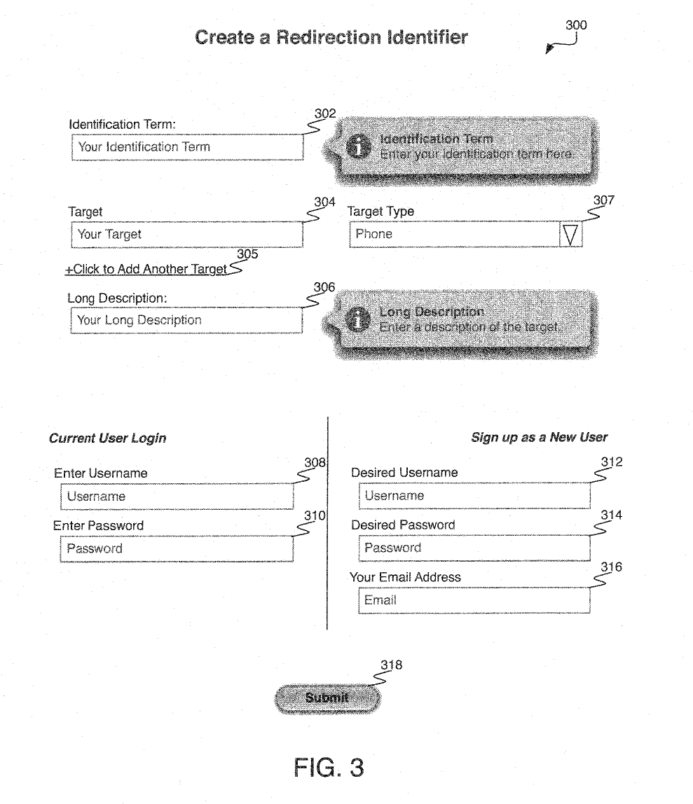

FIG. 3 is a screen shot 300 of a user interface for creation of a redirection identifier. The screenshot 300 may be displayed on a user device as shown in FIG. 1. In a user device, a user enters an identification term 302, a target URL 304 for a target page and a long description 306 for a description of the target URL. The user enters a username 308 (or “login name”) and password 310. Upon pressing the soft button “Submit” 318, the system receives the identification term 302, the target 304 and the long description 306 and creates a redirection identifier. If the user is not registered, the user can sign up to create a new user or username, by entering a desired username 312, a desired password 314, and an email address 316. Upon registering a new user, the actions described regarding blocks 302, 304, 306 and 318 may be repeated by the system to create a redirection identifier. The system validates username 308 and the password 310 to allow for an anchoring of username 308 to the identification term 302. The username 308 is also an account anchor. The identification term 302 is a text description of a web site or other target. The system canonicalizes the identification term 302 and combines it with the account anchor or username (308 or 312) to form the redirection identifier. As used herein, the terms canonical and canonicalize refer to the process of removing all spacing and special characters so that only alphabetical and numerical characters remain in a redirection identifier. The Long Description 306 is a general text description of a web site, used for the purpose of providing a textual explanation of the web site. The Long Description 306 is not canonicalized by the system, is not used in creating a redirection identifier, and is not used in creating a structure of a redirection identifier. A target 304 may also be captured electronically by using an electronic scanning device or bar-code reader that can scan and decode a quick response (QR) code image comprising a URL, phone number, or other information for a target. A camera of a user device may also be used to scan, capture and decode a QR code image.

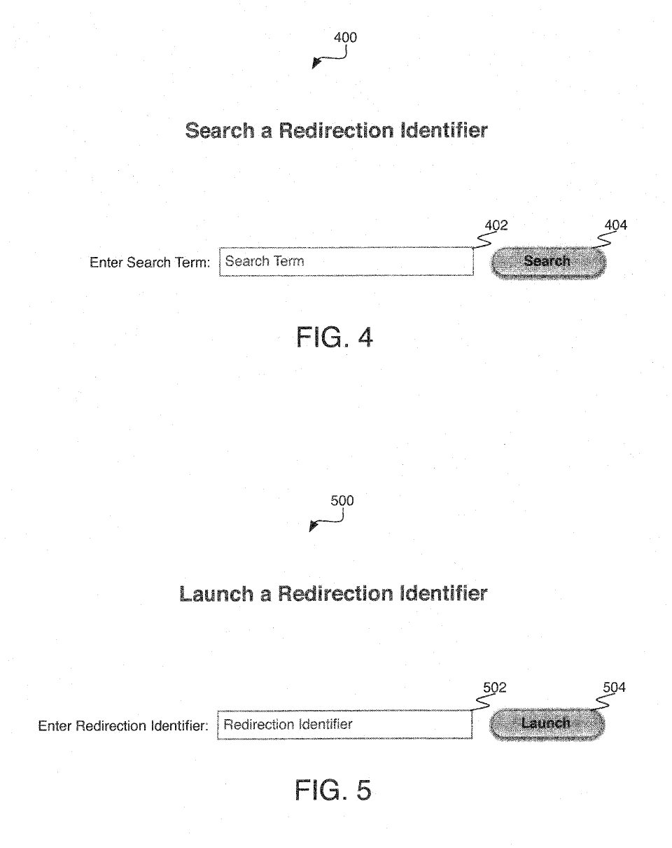

FIG. 4 is a screen shot 400 of a user interface for searching for a redirection identifier. The user interface allows the user to type a search term 402 which is received by the system when the user presses the soft button “Submit” 404. In response, the system provides the user a result page.

FIG. 5 is a screen shot 500 of a user interface for launching a redirection identifier 502. The user interface allows the user to specify a redirection identifier 502 which is received by the system and presses the soft button “Submit” 504. In response, the system provides the user a result page.

An embodiment of the system combines the actions shown and described regarding FIG. 4 and FIG. 5 in a single page or single computer screen, so that pressing the soft button “Submit” (404 or 504), causes the system to either launch an existing redirection identifier or perform a search.

The following example shows the functioning of the method and system for personalized redirection identifiers. A user of a user device, Shane, wants to share his favorite restaurant's website with his friends. Shane accesses the web page of the system (like the computer screenshot diagram 300) in his user device. Shane wants to create a new redirection identifier of the restaurant's website with a name of “Shane's Restaurant.” Shane types in “Restaurant” in the Identification Term 302 and types in the URL of the restaurant as Target 304, both of which are received by the system. Additional target can be added by clicking on the plus sign or the text “click to add another target” 305. Other user interface techniques may be used. In this way redirection identifiers with multiple targets may be specified by a user. The system provides Shane the ability to describe the website with a Long Description 306 so that his friends can have a better idea of what the redirection identifier is about after reading the Long Description 306. The Long Description 306 may not be used to create the structure of the redirection identifier. The Long Description 306 shows a description of the Target 304. The Long Description 306 is received by the system and stored with the Identification Term 302 and one or more Targets 304 entered by Shane.

In another example, user, Bishal, is curious about his friend's favorite songs, so he decides to perform a search for a redirection identifier at the system web page (like computer screenshot 400) using his user device. Bishal enters the term “favorite song” in the Search Term 402 and presses the soft button “Search” 404, and the system receives the search term 402. The system performs a search and the search function displays a list of redirection identifiers having similar terminology as the search term 402, such as, “Sara's Favorite Song”, “Jim's Favorite Song”, “Annie's Favorite Song”, and so forth. From the list presented by the system on his user device, Bishal selects his friend Jim's “Jim's Favorite Song.” Next time Bishal can directly enter “Jim's Favorite Song” at the system web page and hit the soft button “Launch” 504 to launch the target on his user device. The target may be, for example, a web site that includes biographical information about the song and an online streaming version of the song, or may be a web page at a retailer website where the song may be sampled and purchased.

In another example, user Jim, wants to listen to his favorite song. He visits the web page for the system, and the system presents him a data entry web page (such as computer screenshot 400) on his user device. As he is logged into the system website, he is not required to include his own username for input with a redirection identifier, instead the system allows him to input (by typing in) “My Favorite Song” and hits the soft button “Launch” 504. In response the system launches his “Jim's Favorite Song” redirection identifier. In one embodiment, when a user is logged into the system, the system will automatically substitute for the word “my” that user's name.

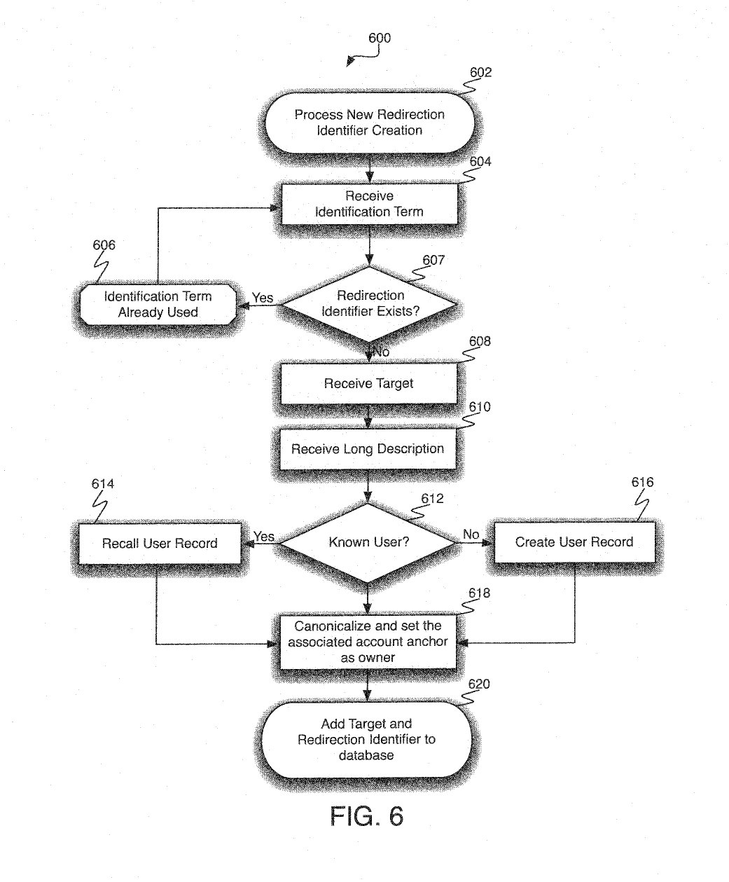

FIG. 6 is a flow diagram of a method 600 for creating a redirection identifier. Starting at block 602 for processing a new redirection identifier, the system receives user input of a desired identification term 302 at block 604. At block 607, the system evaluates if a redirection identifier having the same name of the identification term 302 entered in block 604 already exists. The system also evaluates whether the redirection identifier is associated with the username 308. If the redirection identifier already exists, the system provides the user with an indication that the identification term 302 is already used in block 606, and block 604 is repeated. If the desired identification term 302 (block 604) has not been previously assigned to the username 308, the system at block 608 successfully receives the entry of a target 304, which may be, as described above, a URL, email address, phone number, etc. The system then prompts the user for and receives entry of a long description 306 of the target at block 610. If the user elects not to provide a long description 306 of the target at block 610 by leaving the entry of a long description 306 of the target blank or empty, the system may automatically determine a long description 306 by extracting or otherwise accessing a text description or text information from the website of the URL of the target 304 entered at block 608, may determine that the target is a phone number and automatically populate the long description as a phone number; may look up the phone number in a directory to determine the person or business associated with the phone number; may determine from the format of the target that it is a package tracking number or credit card number and automatically populate the long description accordingly.

At block 612, the system evaluates if the username 308 exists. If the username 308 exists, at block 614 the system recalls the user's record. If the username 308 does not exist, at block 616 the system prompts the user to create a new username 312 as shown in method 300. After a known user is found at block 612 and the user's record is recalled at block 614, at block 618 the system canonicalizes the identification term 302 and sets the associated username 308 as the owner. At block 620 the system will record the redirection identifier in a database table.

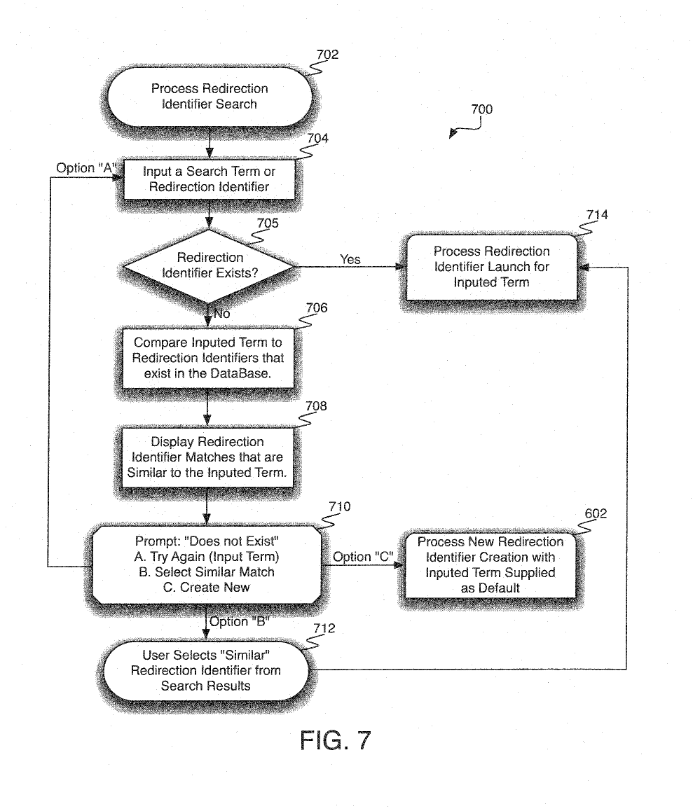

FIG. 7 is a flow diagram of a method 700 illustrating a method for searching a redirection identifier. At block 702, the system provides a user entry screen 400 as shown in FIG. 4. The system receives user input of a search term or redirection identifier at block 704. At block 705, the system determines if the redirection identifier exists. If the redirection identifier exists, at block 714 the system launches the redirection identifier. If the redirection identifier does not exist, the system at block 706 compares the search term to the terms that are available in the system's redirection identifier database. At block 708, the system displays matching redirection identifiers found in the redirection identifier database. At block 710, the system provides the user three options: (A) Try Again; (B) Select Similar Match; and (C) Create New. When the user chooses option A, the system proceeds to block 704. When the user chooses option B, the system proceeds to block 712 where the user is provided a list of similar matching redirection identifiers to select a matching redirection identifier. The system then proceeds to block 714, where the target for the redirection identifier is launched, taking the user to the desired target. When the user chooses option C, the system proceeds to block 602 of the method 600 to create a new redirection identifier.

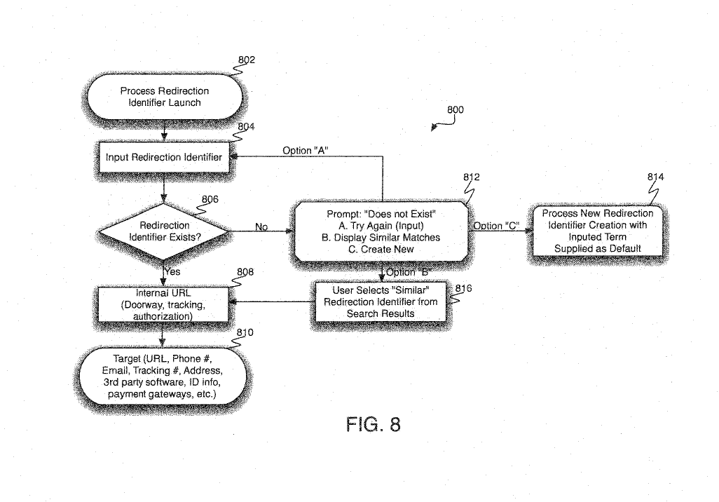

FIG. 8 is a flow diagram of a method 800 illustrating the steps for launching a redirection identifier. At block 802, the system provides a user a screen display 500 as shown in the FIG. 5. At block 804, the system receives user input of a redirection identifier. At block 806, the system determines if the redirection identifier exists. If the redirection identifier exists, upon the user selecting the redirection identifier, the system redirects the user at block 808, after an optional predetermined wait period, to an internal doorway and tracking page, which is also an internal URL. After the wait period is over or immediately, the target launched by the system at block 810. If the redirection identifier does not exist at block 806, the system proceeds to block 812 where the system provides the user three options: (A) Try Again; (B) Select Similar Match; and (C) Create New. When the user chooses option A, the system proceeds to block 804. When the user chooses option B, the system proceeds to block 816 where the system gives the user the opportunity to select a similarly matching redirection identifier displayed by the system, proceeding to block 808, an internal doorway and tracking page. When the user chooses option C, the system proceeds to block 814 to create a new redirection identifier according to the method 600.

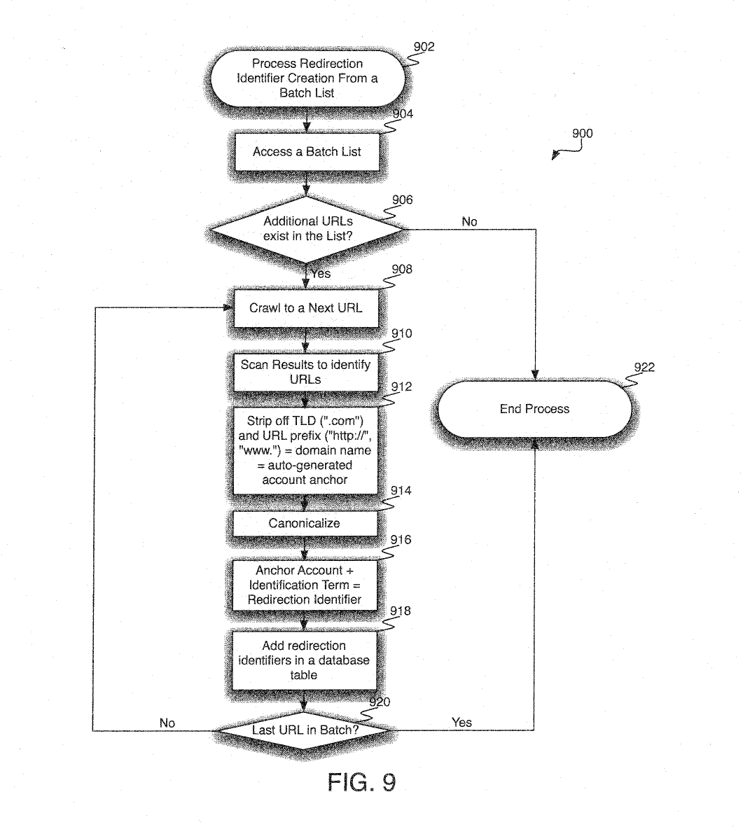

FIG. 9 is a flow diagram of a method 900 or batch process illustrating creation of redirection identifiers from a batch list of URLs. A batch list is a list with a plurality of URLs for which redirection identifiers may be created. Batch lists may be used for high volume applications. In a high volume application, multiple methods may be applied to create redirection identifiers, and to get an access to a plurality of URLs at a higher speed and to convert the URLs to redirection identifiers at a similar high speed. One of these methods may employ a technique called crawling. Crawling is a process of loading the content of a target URL to obtain additional hierarchical or tree data structure of the URLs and to identify keyword descriptions of the hierarchical or tree data structure of the URL. In this way the method 900 may be employed to create redirection identifiers based on or using the data located and obtained from crawling hierarchical or tree data structures of URL pages. When the process is initialized at block 902, the system accesses a batch list of URLs at block 904. If no additional unprocessed URLs exist at block 906, then the method 900 ends at block 922.

If additional unprocessed URLs exist in the list at block 906, the system moves to block 908. At block 908, the system crawls to the next URL in the list. While crawling, the system at block 910 attempts to determine if any URL in the list, or hierarchical or tree data structure of the URL, may have been used previously to create a redirection identifier. In a batch process, it may not be necessary to provide an account anchor. Before initiating a batch process, the system may receive a user provided account anchor for the process, or the system may auto-generate an account anchor when an account anchor is not provided by the user. When an account anchor is not supplied, the system at block 912 will auto-generate an account anchor by stripping off the TLD (“.com,” “.net,” “.org”) and the domain prefix (“http://” and/or “www”) from a web-site address or URL address, so that only a domain name remains. (TLD is an acronym for Top Level Domain—.com, .net, .org, etc are TLDs.) The domain name in this format may be used as an auto-generated account anchor. For example, when an account anchor is not supplied, a domain name without “http://www.” and without “.com” may be used in place of the account anchor. At block 914, the system canonicalizes the identification term to create a redirection identifier at block 916. The system stores the redirection identifier in a database at block 918. The database may be a table, hierarchical, relational or other form of database. At block 920, the system tests if a last URL in the batch list has been processed. If the last URL has been processed, the system ends processing at block 922. If the last URL has not been processed, the system loops to block 908.

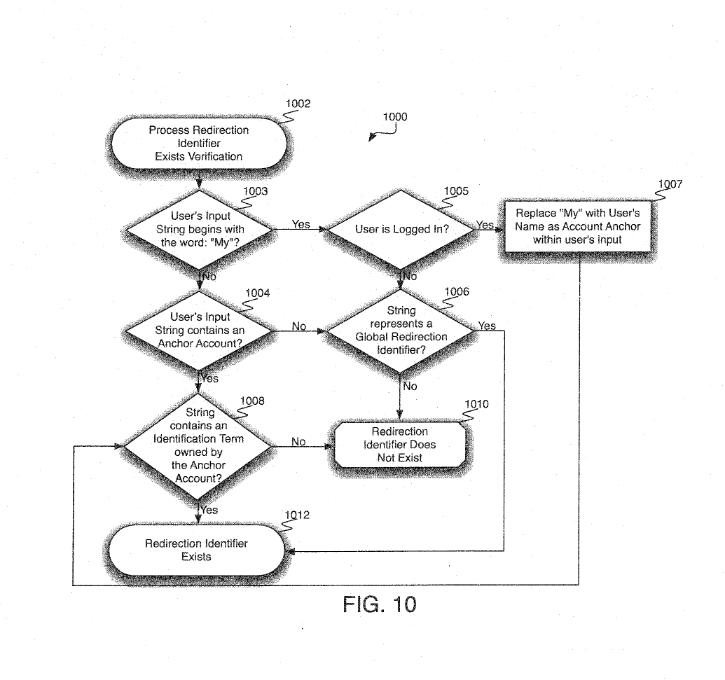

FIG. 10 is a flowchart 1000 showing a verification of redirection identifiers that may exist in a database table. The process starts at block 1002. At block 1004, the system prompts a user for and a user inputs a character string that may be an account anchor or an identification term or a combination of both. In response, the system performs a search of its database for the input character string. During the search, if the system determines that the account anchor is not present, at block 1006 the system evaluates if the string represents a global redirection identifier. If the string represents a global redirection identifier, it will be so indicated by the system at block 1012. If the string does not represent a global redirection identifier at block 1006, the system moves to block 1010 and provides notification to the user that a redirection identifier having the user specified character string does not exist. In the system database, a global redirection identifier is searchable by an identification term alone, without requiring an account anchor or username as a part of the launch input. However, in a system database table for storing redirection identifiers, a global redirection identifier may be shown as being tied to an account anchor for the purpose of facilitating the search process. If an account anchor is present at block 1004, the system moves to block 1008 to further check if the string contains an identification term owned by the account anchor. At block 1008, if the system determines that the input string does not contain the identification term associated with the account anchor, the system moves to block 1010 and provides notification to the user that a redirection identifier having the identification term does not exist. If the received user input contains an identification term, the system at block 1012 provides the user confirmation that a redirection identifier exists.

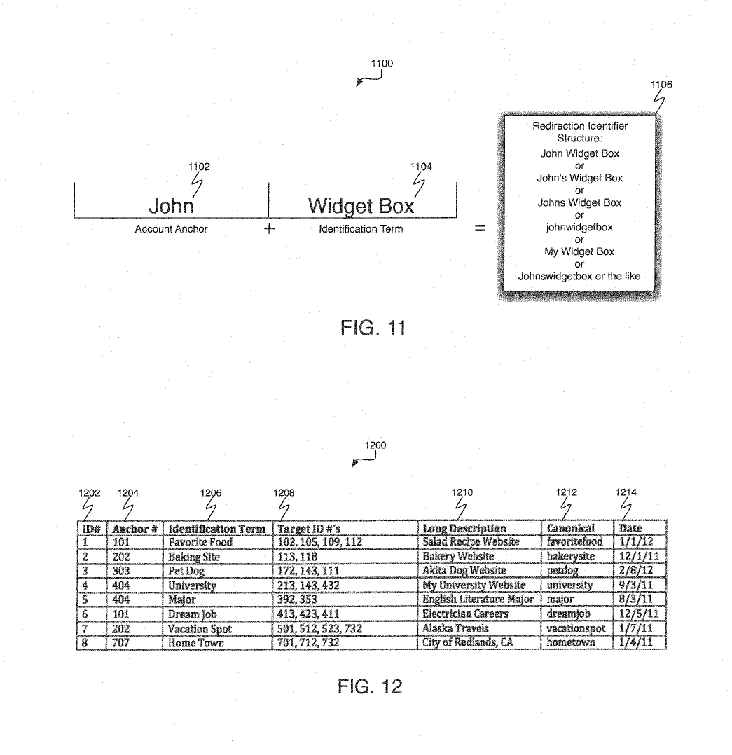

FIG. 11 is a diagram showing a structure of a redirection identifier produced according to the method and system for personalized redirection identifiers. An account anchor 1102 may be combined with an identification term 1104. An account anchor 1102 is also called an anchor term, anchor account, username, or user. In the system described herein, the combination of the account anchor 1102 and the identification term 1104 yields the structure of a redirection identifier. The structure of the redirection identifier has variations as shown by Redirection Identifier Structure 1106. One structure of the redirection identifier is the substitution of the word “my” in the place of the user's name for a user that has logged in. If a user has logged in, instead of typing “user's identification term” the user simply inputs “my identification term.” In another embodiment, the user may input only “identification term” and the system automatically prepends the user's name or login name.

FIG. 12 is an embodiment of a database table 1200 where a redirection identifier may be stored. In this embodiment, column 1202 stores internal numerical identification numbers, column 1204 stores anchor numbers, column 1206 stores identification terms, column 1208 stores target IDs, column 1210 stores Long Description of the associated URLs, column 1212 stores canonicalized versions of identification terms, and column 1214 stores creation dates of redirection identifiers.

The following example shows application of the system and methods to the web site of a university. In this example, Jenny is a website administrator for Home State University (HSU). She wants to create redirection identifiers for a new section of the HSU website which has hundreds of pages. From her system administration account, she goes to the system website and initiates method 900 (as shown by the FIG. 9) by entering the URLs for the new sections, and submits a request to start processing according to the method described herein. The system proceeds by crawling the section of the URLs, and gathering pages of the URLs and the titles; prepending the titles (identification terms) with the account anchor (Jenny's system administration account in HSU website); and computing a redirection identifier for each URL for the new section of the HSU website. Using the system, Jenny can edit, approve or delete the redirection identifiers. For example, “HSU Science Club” is a redirection identifier that is associated with the university's science club. When a user of the HSU website, Shane, wants to check updates to his university's science club, instead of typing in the full URL for the science club, Shane simply types in “HSU Science Club” at the system web page to perform a search. The target page, that is, the web site of the university's science club, is identified by the system and thereby launched on Shane's user device directly after entering “HSU Science Club”.

In on embodiment, a web browser may be configured to launch the target page and may use a web browser plug-in developed for creating, searching and launching a redirection identifier. In addition to a web-browser plug-in, a separate or stand-alone redirection identifier application may also be used for creating, searching and launching a redirection identifier.

In a related example, another user, Bishal, new to HSU, would like to join a university club but is not sure which campus in the HSU has a club or where it is located. Bishal types in “HSU Clubs.” In his search, the search term “HSU Clubs” does not match any existing redirection identifiers in the database. The search result lists existing redirection identifiers that closely match the search term. Bishal finds a running club with the redirection identifier “HSU Running Club.” In the future, Bishal will not need to remember the URL or perform a search, but rather he can simply enter the redirection identifier “HSU Running Club” to launch the webpage directly.

In similar ways, the systems and methods described herein may be applied to the web site of a corporation or a government entity such as a city or state.

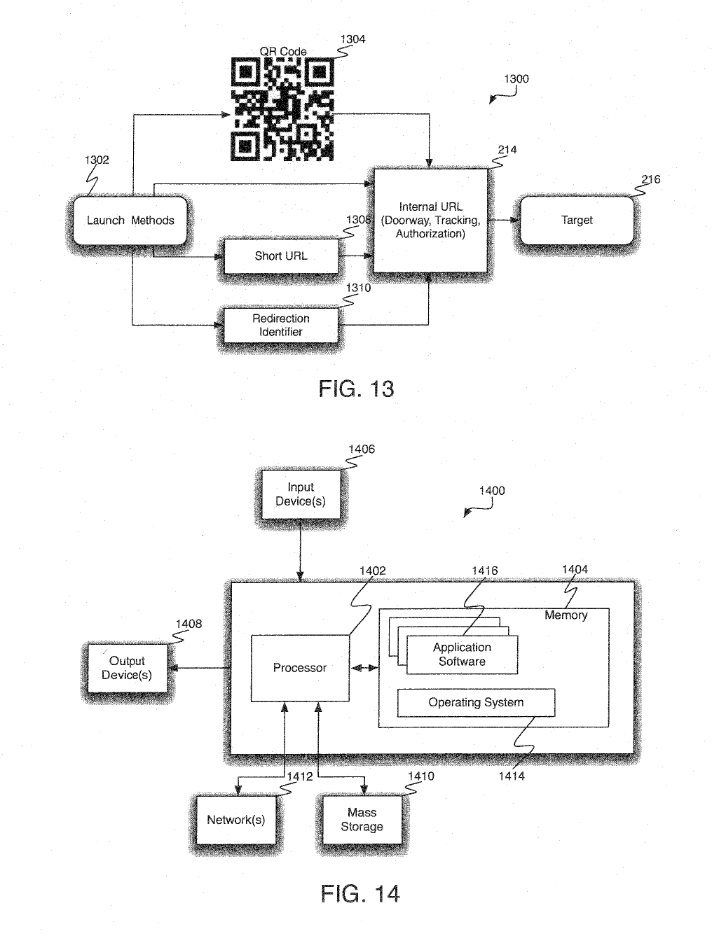

FIG. 13 is a flow diagram of a method showing launch methods of a method and system for personalized social redirection identifiers described herein wherein launch methods 1302 comprise a QR code image 1304, a short URL 1308 and a redirection identifier 1310. The user provides a QR code image 1304, a short URL 1308 and a redirection identifier 1310 to the system. The system passes the QR code image 1304, the short URL 1308 and the redirection identifier 1310 through an Internal URL or Doorway and Tracking Page 214. In one embodiment, a pre-configured wait time may be used to delay accessing the target information or web page. After the pre-configured wait time of the page 214 is over, the system launches an Target 216. When a redirection identifier is created, the system assigns and encodes a scanable QR code image to the redirection identifier to allow a scanning of the QR code image by a user device. With a QR code scanning device being used, a user does not need manually type in a redirection identifier for launching a target URL. A camera of a user device may function as a QR code scanner.

FIG. 14 is a schematic diagram of a computing device. The method and system for personalized redirection identifiers described herein may be implemented in server that is accessed by a user device (described above). A computing device includes a processor 1402, an operating system 1414, application software 1416, memory 1404, at least one input device 1406, at least one output device 1408, a storage device 1410, and a network 1412. There may be multiple instances of each of these components included in or coupled with the computing device. When the computing device is a user device, there may be multiple applications and/or apps. When the computing device is a server, there may be, depending on the kind of server, multiple applications and/or multiple storage devices.

The systems and method described herein may be implemented in software that executes on a server. The systems and methods described herein are implemented on one or more server computers employing many technologies. These technologies may include, for example, Apache web server, PHP application server, MySQL database server, Nitrogen application framework, JavaScript, AJAX (Asynchronous Javascript and XML), Extensible HyperText Markup Language (XHTML), Cascading Style Sheets (CSS), Extensible Markup Language (XML), OAuth (Open Authorization), SOAP (Service-Oriented Architectural Pattern), Secure Sockets Layer (SSL) and Transport Layer Security (TLS), and Model View Controller (MVC).

User devices, also referred to as Internet-capable devices may include a web browser, and the web browser may be augmented with a web browser plug-in to facilitate use of the systems and methods described herein. User devices may interface with third party applications (“apps”), such as, for example, FACEBOOK apps, Forum Scripts (Vbulletin, IPB, phpBB, etc.), CMSs (WORDPRESS, MAMBO, JOOMLA, etc.) and other third party software that may allow inclusion of the features of the systems and methods described herein through a module, application program interface (API), or application development. User devices may include applications or apps that access the systems and methods described herein at a server. A mobile application (“app”) may be developed in a mobile device (such as, an APPLE IPHONE, GOOGLE ANDROID phone, MICROSOFT WINDOWS MOBILE phone) for creating, searching and launching a redirection identifier. A web-browser plug-in may be developed for use in web browsers for creating, searching and launching a redirection identifier.

The systems and methods described herein may be implemented in hardware or in software or a combination of both. Well known components of the system, for example, network interfaces etc., have not been shown, so as not to obscure the features of the systems and methods described herein. However, one of ordinary skill in the art would appreciate that the system includes these components. A user device is a hardware that includes at least one processor coupled to a memory. The processor may represent one or more processors (e.g., microprocessors), and the memory may represent random access memory (RAM) devices comprising a main storage of the hardware, as well as any supplemental levels of memory e.g., cache memories, non-volatile or back-up memories (e.g. programmable or flash memories), read-only memories, etc. In addition, the memory may be considered to include memory storage physically located elsewhere in the hardware, e.g. any cache memory in the processor, as well as any storage capacity used as a virtual memory, e.g., as stored on a mass storage device. Storage devices allow for writing to and/or reading from storage media such as magnetic media such as hard disk drives, optical media such as compact discs (CDs), digital versatile discs (DVDs) and BLU-RAY DISK discs, and silicon or chip based storage media such as silicon storage devices (SSDs) and flash memory media.

The hardware of a user device also typically receives a number of inputs and outputs for communicating information externally. For interface with a user, the hardware may include one or more user input devices (e.g., a keyboard, a mouse, a scanner etc.) and a display (e.g., a Liquid Crystal Display (LCD) panel). For additional storage, the hardware my also include one or more storage devices. Furthermore, the hardware may include an interface with one or more networks (e.g., a local area network (LAN), a wide area network (WAN), a wireless network, and/or the Internet among others) to permit the communication of information with other computing devices coupled to the networks. It should be appreciated that the hardware typically includes suitable analog and/or digital interfaces between the processor and other internal and/or external components.

The hardware operates under the control of an operating system, and executes various computer software applications, components, programs, objects, modules, etc. indicated collectively by reference numerals in FIG. 14 to perform the techniques described above.

The methods described herein may be implemented as a specific application, component, program, object, module or sequence of instructions referred to as “computer programs.” The computer programs typically comprise one or more instructions set at various times in various memory and storage devices in a computer, and that, when read and executed by one or more processors in a computing device, cause the computing device to perform operations to execute the features of the methods described herein. Moreover, while the systems and methods have been described in the context of fully functioning computers and computer systems, those skilled in the art will appreciate that the various embodiments are capable of being distributed as a program product in a variety of forms, such as a computer-readable storage media (described above).

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A server comprising a storage medium having instructions stored thereon which when executed by a processor cause the server to perform actions comprising:
receiving an identification term from a user over the Internet;
receiving a target from a user over the Internet, the target including at least one of a universal resource locator, an address, a phone number, a street address, an email address, a local file address, an FTP address, an IP address;
receiving a long description from a user over the Internet;
creating a redirection identifier by combining the identification term and the target;
creating a database record based on the target, the long description and the redirection identifier.

2. The server of claim 1, wherein the identification term is one selected from group including a user name, a user email address, a user phone number, a user identification number.

3. The server of claim 1, having further instructions stored thereon which when executed by the processor cause the server to perform further actions comprising:
canonicalizing the identification term.

4. The server of claim 1, wherein the long description is a text description of the target.

5. The server of claim 1, having further instructions stored thereon which when executed by the processor cause the server to perform further actions comprising:
retrieving the database record for the redirection identifier from the database when a received search term matches the long description for the redirection identifier.

6. The server of claim 1, wherein the target is captured through a scanning device capable of receiving and decoding a quick response (QR) code image associated with a specific universal resource locator address.

7. The server of claim 1, wherein the target includes at least three of a universal resource locator, an address, a phone number, a street address, an email address, a local file address, an FTP address, an IP address.

8. The server of claim 17, having further instructions stored thereon which when executed by the processor cause the server to perform further actions comprising:
providing a list of target items from the target when a received search term matches the long description for the redirection identifier.

9. The server of claim 18, having further instructions stored thereon which when executed by the processor cause the server to perform further actions comprising:
receiving user selection of one of the target items.

10. The server of claim 17, having further instructions stored thereon which when executed by the processor cause the server to perform further actions comprising:
receiving user device information;
selecting a selected target item from the list of target items based on the user device information when a received search term matches the long description for the redirection identifier;
instructing the user device to automatically launch the selected a target item.

11. A method comprising:
receiving an identification term from a user over the Internet;
receiving a target from a user over the Internet, the target including at least one of a universal resource locator, an address, a phone number, a street address, an email address, a local file address, an FTP address, an IP address;
receiving a long description from a user over the Internet;
creating a redirection identifier by combining the identification term and the target;
creating a database record based on the target, the long description and the redirection identifier.

12. The method of claim 11, wherein the identification term is one selected from group including a user name, a user email address, a user phone number, a user identification number.

13. The method of claim 11, further comprising:
canonicalizing the identification term.

14. The method of claim 11, wherein the long description is a text description of the target.

15. The method of claim 11, further comprising:
retrieving the database record for the redirection identifier from the database when a received search term matches the long description for the redirection identifier.

16. The method of claim 11, wherein the target is captured through a scanning device capable of receiving and decoding a quick response (QR) code image associated with a specific universal resource locator address.

17. The method of claim 11, wherein the target includes at least three of a universal resource locator, an address, a phone number, a street address, an email address, a local file address, an FTP address, an IP address.

18. The method of claim 17, further comprising:
providing a list of target items from the target when a received search term matches the long description for the redirection identifier.

19. The method of claim 18, further comprising:
receiving user selection of one of the target items.

20. The method of claim 17, further comprising:
receiving user device information;
selecting a selected target item from the list of target items based on the user device information when a received search term matches the long description for the redirection identifier;
instructing the user device to automatically launch the selected a target item.
